(19) United States
(12) Patent Application Publication
(10) Pub. No.: US 2021/0331903 A1
(43) Pub. Date: Oct. 28, 2021

(54) PORTABLE LIFTING APPARATUS

(71) Applicant: Brian Brooke, Waynesboro, PA (US)

(72) Inventor: Brian Brooke, Waynesboro, PA (US)

(21) Appl. No.: 16/860,629

(22) Filed: Apr. 28, 2020

(51) Int. Cl. B66F 3/36; B66F 3/24; B66F 3/30; B64F 5/10

(52) U.S. Cl. CPC B66F 3/36; B64F 5/10; B66F 3/30; B66F 3/245

(57) ABSTRACT

A portable lifting apparatus for lifting aircraft by an axle including a base member having a housing; a lifting member coupled to the base member, the lifting member configured to move between a first position and a second position, and a coupling member configured to couple the lifting member to an axle of a vehicle, wherein the lifting member raises the vehicle from a first height to a second height when the lifting member is moved from the first position to the second position.

### FIELD OF INVENTION

The present general inventive concept relates to lifting mechanisms and, more particularly, to a portable aircraft lifting apparatus that raises vehicles having an axle, including aircraft, for maintenance or repair.

### BACKGROUND

There have previously been many types of manually operated jacks to raise vehicles such as automobiles, planes, trailers etc. Such jacks include scissor jacks, screw jacks, bottle jacks and floor jacks etc. Today, hand-operated, hydraulic jacks are extremely popular in most garages. Hydraulic jacks use oil to move a cylinder that generates enough force to raise a vehicle. Users position the jack under a vehicle and move a lever back and forth to apply pressure to the oil and cylinder which raises the vehicle up so they can safely change a tire or work underneath.

However, conventional, hydraulic, manual jacks are limited to being attached to specific points along a vehicles chassis so as not to damage the vehicle. These points are not always readily found and are different for each vehicle, especially aircraft.

Therefore, what is desired is a manually operated, hydraulic jack that can be quickly connected to an axle of various types of vehicles, including aircraft, in order to lift the vehicle for repair or wheel replacement.

### BRIEF SUMMARY OF THE INVENTION

An object of the invention is to lift a vehicle by the end of its axle. An exchangeable pin is disposed to the perpendicular to the jack's vertical axis and allows the axle to be lifted to allow a user to repair the vehicle or replace its wheels.

Another object of the invention is to provide a means to allow the device to be compatible with many types of axles on a plurality of vehicles, including automobiles and aircraft etc. Said exchangeable pin is available in a myriad of configurations that will fit into many axle hubs and engage many types of axle studs.

Another object of the invention is to provide a means to keep the jack stable while being installed on an axle. The device includes adjustable outriggers on each side that can accommodate a variety of different diameter wheels and vehicle weights.

Another object of the invention is to enhance safety by means of a redundancy system. The apparatus includes a safety rack that catches the jack if there is a failure with the onboard hydraulic cylinder. Teeth in the rack will engage a locking pawl to prevent the device from lowering further. Also, in order to disengage the safety rack when lowering, a lever is used.

Another object of the invention is to provide a means to carry the apparatus. A handle on each side of the device allows a single person to transport the device and it also helps them position the jack under a wheel of a vehicle.

Another object of the invention is to provide a means to easily move the apparatus while a vehicle is being lifted by the axle. One or more wheels may be attached to the device to allow a single user to move a vehicle being lifted by the axel jack apparatus according to the present inventive concept.

The foregoing and/or other aspects of the present general inventive concept may be achieved by providing a portable lifting apparatus for lifting a vehicle by an axle including a base member having a housing, a lifting member coupled to the base member, the lifting member configured to move between a first position and a second position, and a coupling member configured to couple the lifting member to an axle of a vehicle, wherein the lifting member raises the vehicle from a first height to a second height when the lifting member is moved from the first position to the second position.

The portable lifting apparatus may include a first support arm extending from a first side of the housing and a second support arm extending from a second side of the housing.

A width between the first support arm and the second support arm may be adjustable.

The housing may be formed in a rectangular shape.

The lifting member may include a hydraulic system with a hydraulic cylinder and ram configured to lift the coupling member from the first position to the second position.

The coupling member may include a detachable engagement member configured to have a diameter which corresponds with an internal diameter of the axle of the object.

The second height may be between about 6 inches to about 36 inches from the first height.

The foregoing and/or other aspects of the present general inventive concept may also be achieved by providing a method of using a portable lifting apparatus for lifting a vehicle by an axle which includes a base member having a housing, a lifting member coupled to the base member, the lifting member configured to move between a first position and a second position, and a coupling member configured to couple the lifting member to an axle of a vehicle, wherein the lifting member raises the vehicle from a first height to a second height when the lifting member is moved from the first position to the second position, the method including disposing the base member adjacent to the axle of the object, inserting the coupling member into the axle of the object, and activating the lifting member to lift the coupling member and the axle of the object from the first position to the second position.

The second height may be between about 6 inches to about 36 inches from the first height.

The foregoing and/or other aspects of the present general inventive concept may also be achieved by providing an aircraft axle jack having a base member having a housing, a lifting member coupled to the base member, the lifting member configured to move between a first position and a second position, and a coupling member configured to couple the lifting member to an axle of an aircraft, wherein the lifting member is configured to lift the aircraft via the axle using the coupling member.

The aircraft axle jack may further include a first support arm extending from a first side of the housing and a second support arm extending from a second side of the housing.

A width between the first support arm and the second support arm may be adjustable.

The housing may be formed in a rectangular shape.

The lifting member may include a hydraulic system with a hydraulic cylinder and ram configured to lift the coupling member from the first position to the second position.

The coupling member may include a detachable engagement member configured to have a diameter which corresponds with an internal diameter of the axle of the aircraft.

The second height may be between about 6 inches to about 36 inches from the first height.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device.

It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

FIG. 1 is a front perspective view of a portable lifting apparatus according to an example embodiment of the present general inventive concept;

FIG. 2 is a right-side view of the portable lifting apparatus illustrated in FIG. 1;

FIG. 3 is a back view of the portable lifting apparatus illustrated in FIG. 1;

FIG. 4 is a top view of the portable lifting apparatus illustrated in FIG. 1;

FIG. 5A is a left-side view of the portable lifting apparatus illustrated in FIG. 1;

FIG. 5B is a cross-sectional view of the portable lifting apparatus illustrated in FIG. 4, along line B-B;

FIG. 6A is side view of the portable lifting apparatus illustrated in FIG. 1, coupled to an aircraft wheel in a first position;

FIG. 6B is a side view of the portable lifting apparatus illustrated in FIG. 1, coupled to an aircraft wheel in a second raised position; and

FIGS. 7A-7G illustrate a method of lifting an aircraft or vehicle with a portable lifting apparatus according to an embodiment of the present general inventive concept.

### DETAILED DESCRIPTION OF INVENTION

Reference will now be made in detail to the example embodiments of the present general inventive concept, examples of which are illustrated in the accompanying drawings, wherein like reference numerals refer to the like elements throughout. The exemplary embodiments are described below in order to explain the present general inventive concept by referring to the figures.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

The present general inventive concept provides a novel, safe, and efficient lifting apparatus that is portable for convenient use and is designed to be operable with a wide variety of vehicles, including aircraft. The portable lifting apparatus according to the present inventive concept is also designed to effectively, safely, and quickly lift a vehicle, such as an aircraft, with a single device, tool, or piece of equipment to thereby reduce equipment costs and maintenance time.

The portable lifting apparatus according to the present inventive concept may be manufactured to be compatible with a wide variety of aircraft. That is, the portable lifting apparatus includes an axle coupling member having a detachable engagement member that is designed and/or configured to be detachably coupled to different aircraft axles.

In the present embodiment, the portable lifting apparatus is a multi-platform, 5-ton aircraft landing gear axle jack which simplifies aircraft maintenance and the tire replacement process. However, the present general inventive concept is not limited thereto. That is, in alternative embodiments, the components of the portable lifting apparatus according to the present general inventive concept may be manufactured from strong materials, such as steel, aluminum, titanium, alloys, or various other metal or non-metal material that is capable of supporting the weight of a desired aircraft to lift.

Further, the portable lifting apparatus includes detachable support arms for convenient storage and used to provide counter support when lifting aircraft.

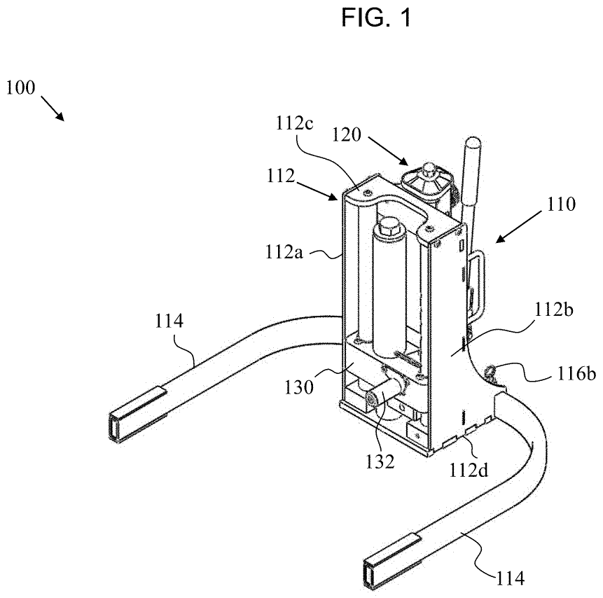

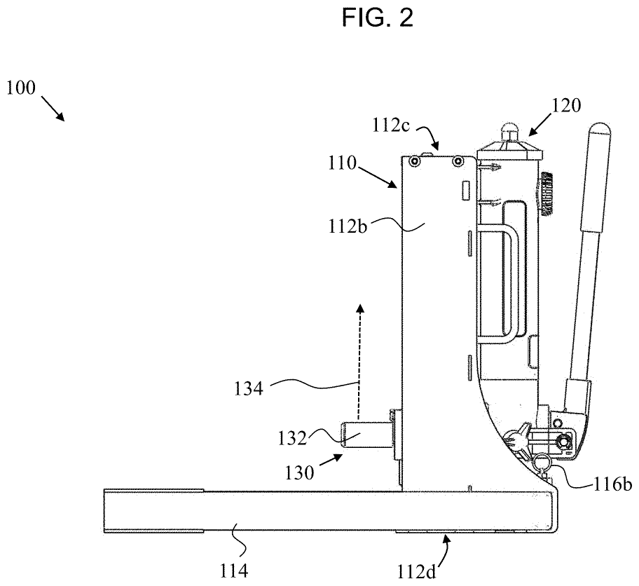

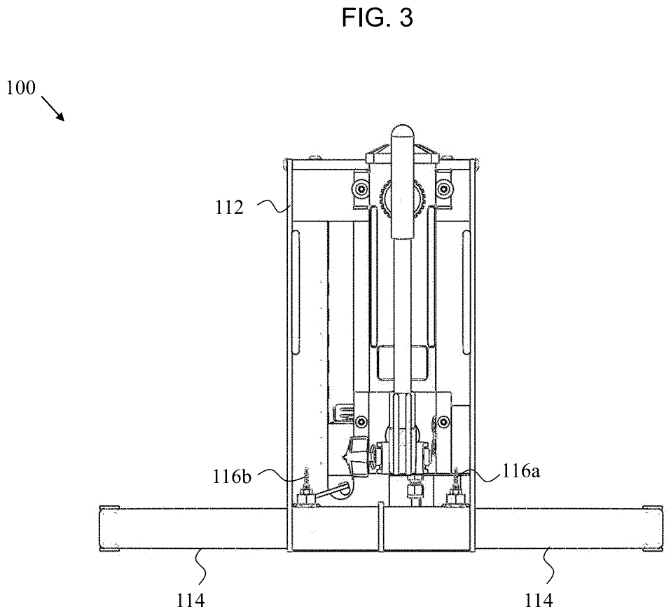

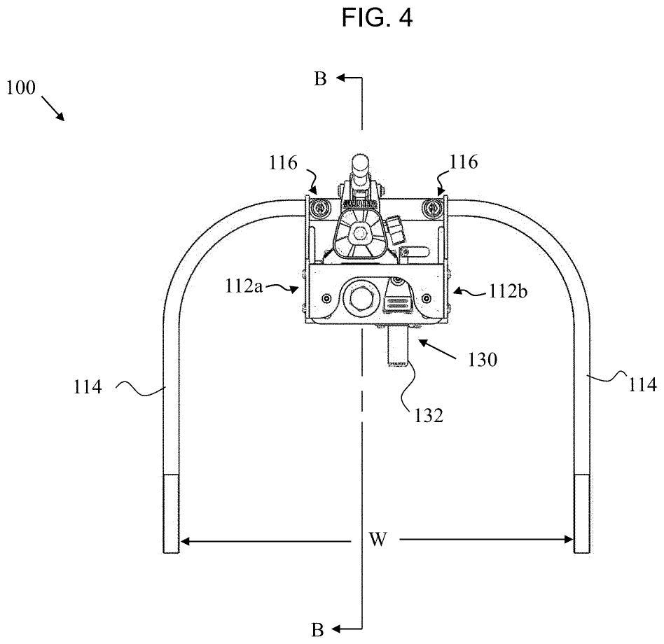

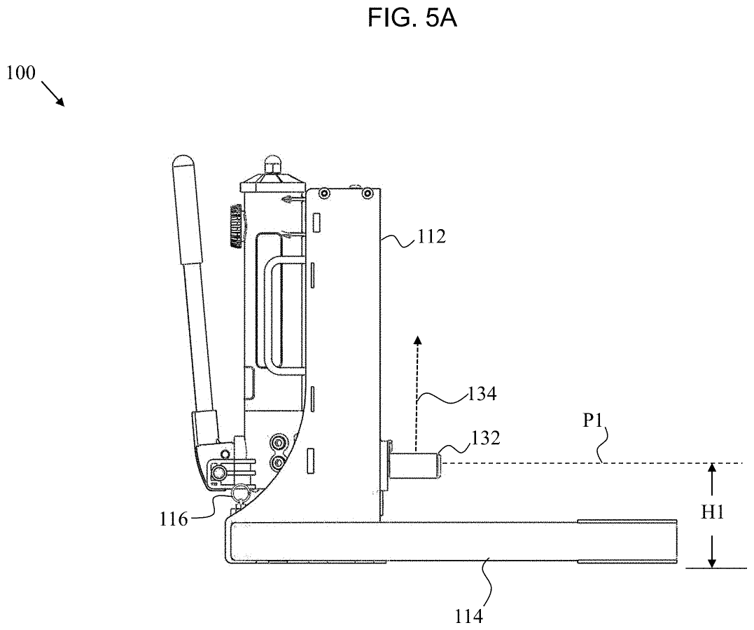

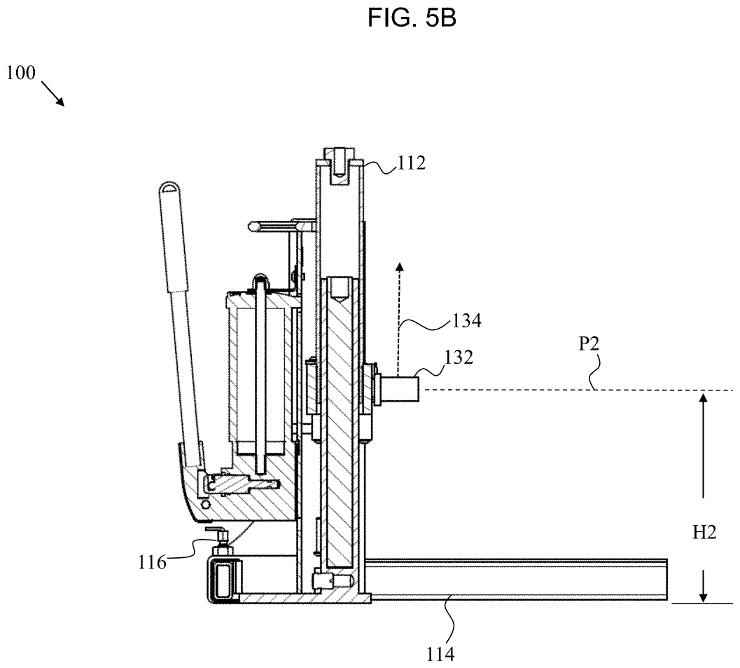

FIG. 1 is a front perspective view of a portable lifting apparatus according to an example embodiment of the present general inventive concept, FIG. 2 is a right-side view of the portable lifting apparatus illustrated in FIG. 1, and FIG. 3 is a back view of the portable lifting apparatus illustrated in FIG. 1. FIG. 4 is a top view of the portable lifting apparatus illustrated in FIG. 1, FIG. 5A is a left-side view of the portable lifting apparatus illustrated in FIG. 1, and FIG. 5B is a cross-sectional view of the portable lifting apparatus illustrated in FIG. 4, along line B-B.

Referring to FIGS. 1-5B, in an embodiment of the present general inventive concept, the portable lifting apparatus (or axle jack) 100 for lifting vehicles, such as aircraft, by an axle includes a base member 110 having a housing 112, a lifting member 120 coupled to the base member 110, and an axle coupling member 130 configured to detachably couple to an axle of a vehicle, such as aircraft.

In the present embodiment, the portable lifting apparatus 100 for lifting a vehicle by an axle includes a base member 110 having a housing 112, a lifting member 120 coupled to the base member 110 and configured to move between a first position P1 and a different second position P2, a coupling member 130 configured to detachably couple the lifting member 120 to the axle of the vehicle. As such, the lifting member 120 raises the vehicle from a first height H1 to a different second height H2 relative to a ground position G when the lifting member 120 is moved from the first position P1 to the second position P2.

In exemplary embodiments, the lifting member 120 raises the aircraft from the first height H1 to the second height H2 which is between about 6 inches to about 36 inches. However, the present general inventive concept is not limited thereto.

In the present embodiment, the housing 112 includes a first side 112a, an opposing second side 112b, a top end 112c, and a bottom end 112d. The housing 112 is designed and constructed of a durable, high strength rigid material such as, but not limited to, sheet metal, solid metal or the like, and yet be of a lightweight construction for ease of portability and use.

In the present embodiment, the housing 112 of the base member 110 and is formed in a substantially rectangular shape. However, the present general inventive concept is not limited thereto. That is, in alternative embodiments, the housing 112 may be formed in various shapes and sizes, as desired, to accommodate different types of vehicles or aircraft.

In the present embodiment, the lifting member assembly 120 is configured to lift vehicles, including aircraft, by lifting the aircraft by an axle coupled to the axle coupling member 130. That is, the portable lifting apparatus 100 is configured to lift aircraft to a predetermined height from the ground position G when the axle coupling member 130 is raised from a first position P1 (i.e. wheel 12 on the ground position G) to a second position P2 (i.e., wheel 12 raised off the ground position G). However, the present general inventive concept is not limited thereto.

That is, in alternative embodiments, the lifting member assembly 120 may be raised to incremental positions between the first position P1, when the aircraft wheel 12 is on the ground, and the second position P2, when the aircraft wheel 12 is lifted off the ground.

In the present embodiment, the axle coupling member 130 includes a detachable engagement member 132 (i.e. lifting pin) that is designed and configured to correspond to an axle of a specific vehicle or aircraft. That is, in the present embodiment, the detachable engagement member 132 includes an outer diameter that is the substantially the same as the internal diameter of the axle to a small-sized aircraft.

Referring to FIG. 1, the detachable engagement member 132 may be detachably coupled to the axle coupling member 130. In alternative embodiments, the detachable engagement member 132 may be replaced with various sized engagement members 132 having different outer diameters to correspond with or match internal diameters of axles of different types of aircraft. However, the present general inventive concept is not limited thereto.

In the present embodiment, the portable lifting apparatus 100 includes a first support arm 114 extending from a first side of the housing 112a and a second support arm 114 extending from a second side of the housing 112b. The first and second support arms 114 are universal and may be inserted on either side of the housing 112. The first and second support arms 114 provide increased stability and support when the aircraft is raised or lowered, reducing a likelihood of the base member 130 buckling or succumbing to a moment force created when lifting the aircraft. As such, the first and second support arms 114 prevent the portable lifting apparatus 100 from tilting or collapsing, especially for larger aircraft. In alternative embodiments, a width W between the first support arm and the second support arm may be adjustable in order to accommodate various sized aircraft axles and wheels 12.

In the present embodiment, the portable lifting apparatus 100 includes a first quick disconnect pin 116a disposed on the first side of the housing 112a and a second quick disconnect pin 116b on the second side of the housing 112b. The first and second quick disconnect pins 116 allow for the first and second support arms 114 to be detachably coupled to the housing 112. As such, a user may easily install or detach the support arms 114 from the housing 112 of the base member 110 by pulling on the quick disconnect pins 116 and installing or detaching the support arms 114.

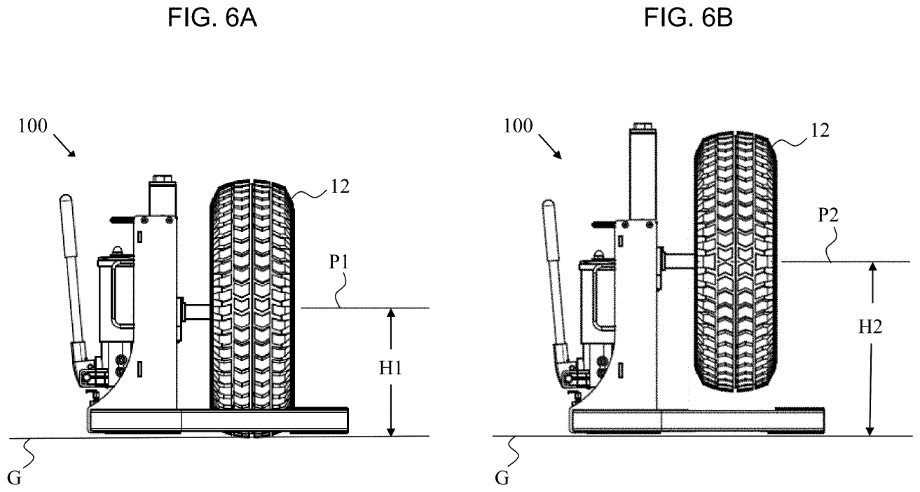

FIG. 6A is side view of the portable lifting apparatus 100 illustrated in FIG. 1, coupled to an aircraft wheel in a first position and FIG. 6B is a side view of the portable lifting apparatus 100 illustrated in FIG. 1, coupled to an aircraft wheel in a second raised position.

Referring to FIGS. 6A and 6B, in exemplary embodiments, the lifting member 120 includes a hydraulic system 122 with a hydraulic cylinder 124 and ram 126 configured to lift the axle coupling member 130 and aircraft from the first position P1 to the second position P2. However, the present general inventive concept is not limited thereto. That is, in alternative exemplary embodiments, the lifting member 120 may include

In the present embodiment, the lifting member 120 includes a pump member 122 with a movable handle 124 coupled to the housing 112 and a hydraulic cylinder 124 and a ram 126 disposed within the housing 112 that are used to move the axle coupling member 130 between the first position P1 and the second position P2, which, in turn, moves the aircraft wheel 12 from the first position P1, when the aircraft wheel 12 is on the ground G, to the second position P2, when the aircraft wheel 12 is lifted off the ground G. As such, when the movable handle 124 is moved, hydraulic fluid is forced into the hydraulic cylinder 124 thereby moving/lifting the axle coupling member 130. However, the present general inventive concept is not limited thereto. That is, in alternative example embodiments, the lifting member 120 may include various other types of hydraulic lifts, pneumatic lifting assemblies, or other means for lifting that are designed to generate the necessary lifting force to lift or raise a vehicle or aircraft.

Referring to FIG. 2, the lifting member 120 is operably configured to place/move the axle coupling member 130 and the detachable engagement member 132 at a plurality of raised height positions with respect to a lower end 112d of the housing 112. A representative path in which the detachable engagement member 132 may translate to generate the plurality of height positions is depicted with arrow 134.

As may be appreciated by those of ordinary skill, an actuation of the lifting member 120 causes the axle coupling member 130 to raise to the plurality of height positions along the path 134. As such, the vehicle or aircraft coupled to the detachable engagement member 132 is also raised to the plurality of height positions along the path 134.

Referring to FIGS. 6A and 6B, in the present embodiment, the lifting member 120 raises the aircraft wheel 12 from a first height H1 from the ground G to a second height H2 from the ground G, when the axle coupling member 130 is moved from a first position P1 of the plurality of height positions to a second position P2 of the plurality of height positions.

In alternative exemplary embodiments, the lifting member 120 further includes a safety rack 126 designed with a plurality of teeth to engage and lock the coupling member 130 in place.

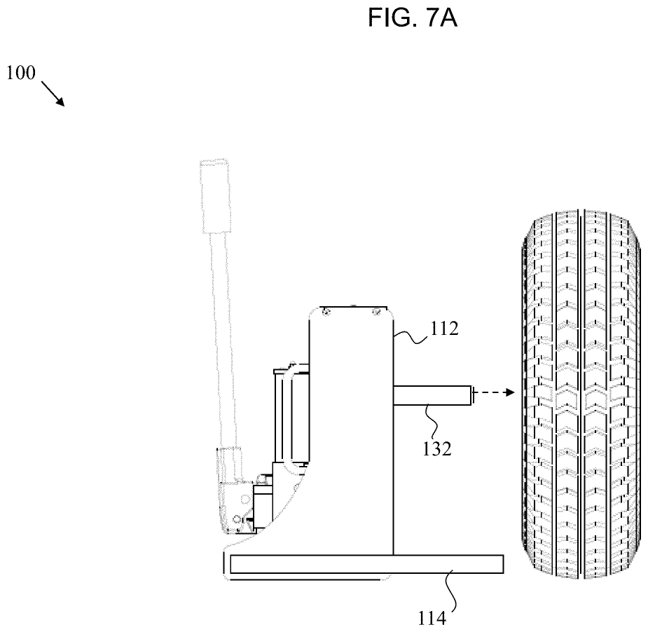

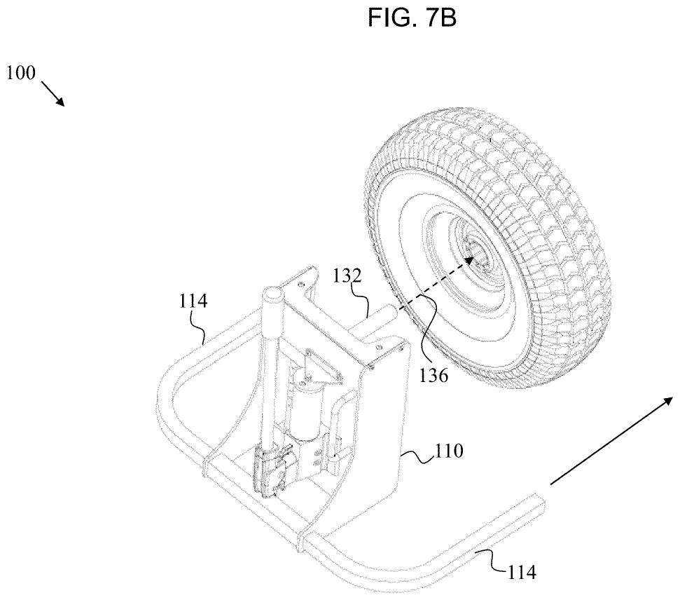

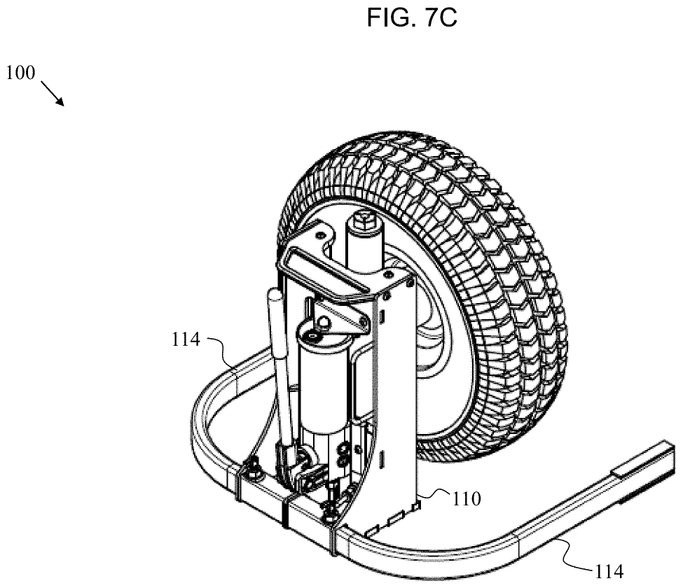

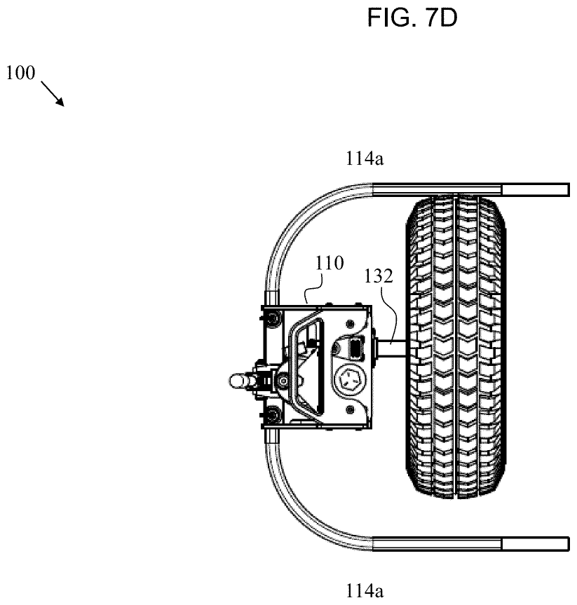

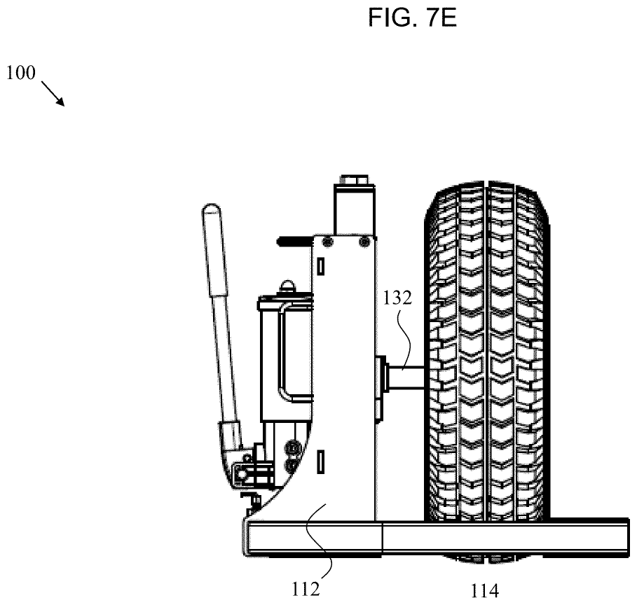

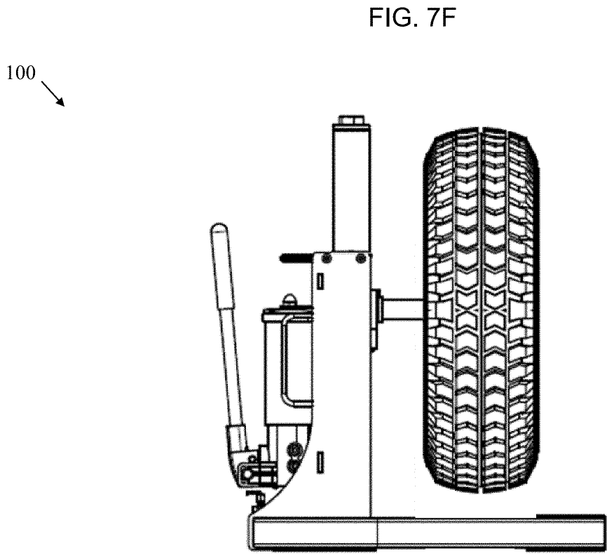

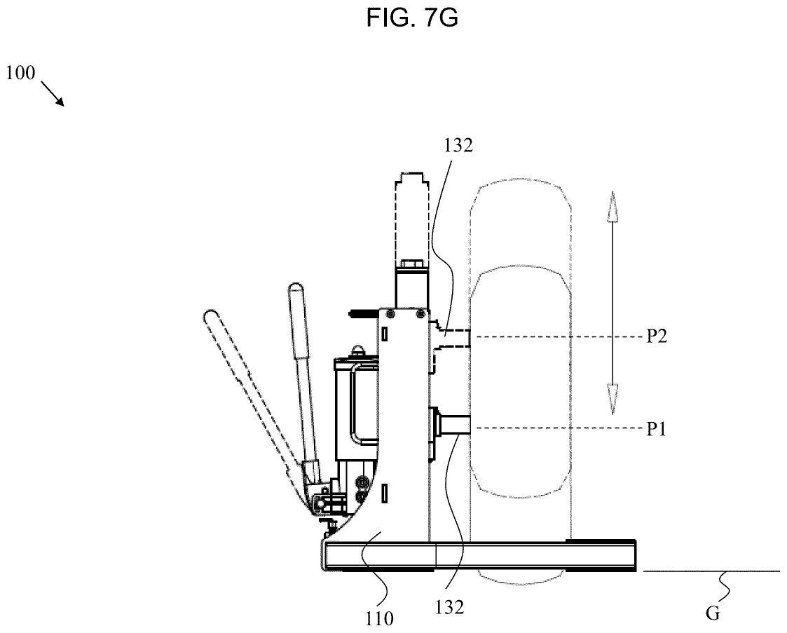

FIGS. 7A-7G illustrate a method of lifting an aircraft or vehicle with a portable lifting apparatus according to an embodiment of the present general inventive concept.

In operation, the portable lifting apparatus 100 is first placed adjacent to the wheel 14 of the aircraft 10. Next, the width W1 between the first and second support arms 110a, 110b are adjusted to accommodate various sized objects, such as the wheel 14 of the aircraft 10. Next, the engagement member 132 of the coupling member 130 is inserted within the axle 12 of the aircraft 10

Next, the pump member 122 of the lifting member 120 is activated to lift the coupling member 130 from the first position (on the ground) to the second position to perform maintenance or other repairs to the aircraft 10. In the present embodiment, the movable handle 124 is moved up and down in order to activate the pump member 122 to move the coupling member 130. However, the present general inventive concept is not limited thereto. That is, in alternative embodiments, a motor (not illustrated) may be used to activate the pump member 122 to move the coupling member 130 between the first position and the second position to thereby raise the aircraft 10.

In the present embodiment, as the aircraft 10 is raised the plurality of teeth 128 of the safety rack 126 engages and secures the coupling member 130 in place, as a safety measure. When maintenance or repairs are complete, the pressure stored within the hydraulic cylinder 124 is released by turning a release member and the plurality of teeth 128 are disengaged from the coupling member 130.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A portable lifting apparatus for lifting a vehicle by an axle, comprising:
a base member having a housing;
a lifting member coupled to the base member, the lifting member configured to move between a first position and a second position; and
a coupling member configured to couple the lifting member to an axle of a vehicle,
wherein the lifting member raises the vehicle from a first height to a second height when the lifting member is moved from the first position to the second position.

2. The portable lifting apparatus of claim 1, further comprising a first support arm extending from a first side of the housing and a second support arm extending from a second side of the housing.

3. The portable lifting apparatus of claim 2, wherein a width between the first support arm and the second support arm is adjustable.

4. The portable lifting apparatus of claim 1, wherein the housing is formed in a rectangular shape.

5. The portable lifting apparatus of claim 1, wherein the lifting member includes a hydraulic system with a hydraulic cylinder and ram configured to lift the coupling member from the first position to the second position.

6. The portable lifting apparatus of claim 5, wherein the coupling member includes a detachable engagement member configured to have a diameter which corresponds with an internal diameter of the axle of the object.

7. The portable lifting apparatus of claim 1, wherein the second height is between about 6 inches to about 36 inches from the first height.

8. A method of using a portable lifting apparatus for lifting a vehicle by an axle which includes a base member having a housing, a lifting member coupled to the base member, the lifting member configured to move between a first position and a second position, and a coupling member configured to couple the lifting member to an axle of a vehicle, wherein the lifting member raises the vehicle from a first height to a second height when the lifting member is moved from the first position to the second position, the method comprising:
disposing the base member adjacent to the axle of the object;
inserting the coupling member into the axle of the object; and
activating the lifting member to lift the coupling member and the axle of the object from the first position to the second position.

9. The portable lifting apparatus of claim 8, wherein the second height is between about 6 inches to about 36 inches from the first height.

10. A portable lifting apparatus comprising:
a base member having a housing;
a lifting member coupled to the base member, the lifting member configured to move between a first position and a second position; and
a coupling member configured to couple the lifting member to an axle of an aircraft,
wherein the lifting member is configured to lift the aircraft via the axle using the coupling member.

11. The portable lifting apparatus of claim 10, further comprising a first support arm extending from a first side of the housing and a second support arm extending from a second side of the housing.

12. The portable lifting apparatus of claim 11, wherein a width between the first support arm and the second support arm is adjustable.

13. The portable lifting apparatus of claim 10, wherein the housing is formed in a rectangular shape.

14. The portable lifting apparatus of claim 10, wherein the lifting member includes a hydraulic system with a hydraulic cylinder and ram configured to lift the coupling member from the first position to the second position.

15. The portable lifting apparatus of claim 14, wherein the coupling member includes a detachable engagement member configured to have a diameter which corresponds with an internal diameter of the axle of the aircraft.

16. The portable lifting apparatus of claim 10, wherein the second height is between about 6 inches to about 36 inches from the first height.
